(19) United States
(12) Patent Application Publication
(10) Pub. No.: US 2006/0007781 A1
(43) Pub. Date: Jan. 12, 2006

(54) Formula mixing appliance

(76) Inventors: William Martin, Mountain Home, ID (US); Conrad Setoki, Mountain Home, ID (US)

Correspondence Address: ROBERT L. SHAVER, DYKAS, SHAVER & NIPPER, LLP, PO BOX 877, BOISE, ID, 83701-0877, US

(21) Appl. No.: 10/887,369

(22) Filed: Jul. 6, 2004

(51) Int. Cl. B01F 13/08

(52) U.S. Cl. 366/274

(57) ABSTRACT

An appliance for measuring and mixing dry ingredients such as baby formula with a liquid such as water, heating the water to a desired temperature, and mixing the two ingredients together in the appliance. The result is a liquid food, which is at a desired temperature for use by a consumer.

### BACKGROUND OF THE INVENTION

1. Field of the Invention

The present invention generally relates to mixing appliances, and more particularly relates to appliances for mixing a dry ingredient with a liquid at a specified temperature.

2. Background Information

There are many situations in which it is desirable to mix a dry ingredient with a liquid ingredient at a certain temperature. One specific example of when this might be required is when a person wishes to mix powdered baby formula with warm water in order to make liquid baby formula. In the prior art, this is accomplished by measuring a scoop of powdered baby formula and placing it inside a bottle. Water is brought to the correct temperature and then added to the bottle. The liquid and powder are mixed together to form a warm baby formula. There are numerous appliances that attempt to automate this process. However, none of them have the feature of dispensing the powdered ingredient into a container, warming and dispensing a measured quantity of liquid into the same container, and mixing the two together.

What is needed is an appliance in which one or more dry ingredients can be stored in one or more compartments. A water source is needed, and a temperature control system to bring the water to the desired temperature. What is further needed is a mechanism for measuring and dispensing measured quantities of the dry ingredient and the liquid into a container. The container then needs to be mixed.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other objects are accomplished by the mixing appliance invention. This appliance is designed for mixing a dry ingredient with a liquid to form liquid foods. It includes one or more storage compartments for storing the dry ingredient. It also includes a liquid source that can be an onboard container which may be optionally removed for filling and cleaning, or which may be a connection to the plumbing system of a building. The temperature control system is for heating the liquid, which will often be water, to the desired temperature, which is selected by a user in a temperature selection device. The temperature control system can heat the water in the container or it can heat water as it enters the appliance from the building plumbing system so that it arrives at a container at the correct temperature. The device includes a first measuring unit for measuring a quantity of the dry ingredient. Once measured, the first measuring unit sends the measured quantity of dry ingredient to a container for mixing. The unit also includes a second measuring unit, for measuring a quantity of liquid for mixing. This measurement would typically be a volumetric measurement, but could also be by weight. A container is provided on the mixing appliance in which the measured quantity of dry ingredient are mixed with a measured quantity of liquid. The container is removable from the mixing appliance, and in the case of a baby formula application, would be a baby bottle. The mixing appliance of the invention also includes a mixing system for mixing the measured quantity of dry ingredient and the measured quantity of liquids, until they are blended together to form a solution.

It is possible that the mixing appliance of the invention can be configured to mix multiple dry ingredients. In such a case it would have multiple storage compartments for storing the dry ingredients and one or more first measuring units for measuring quantities of the dry ingredients. In either configuration, the first measuring unit can be a screw type measurer, such as an auger or some other type of rotating screw, which carries quantities of dry ingredients along with the rotation of the screw. The first measuring unit can also be weight based, and weigh out a certain selected weight of dry ingredients for addition to the container. One type of first measuring unit can be based on a disk, which has a volume based measuring depression. As the disk rotates through the dry ingredients, the depression in the disk automatically measures the quantity of dry ingredients and transfers it to a container for mixing.

The mixing system can take a number of configurations. It would typically include a mixing motor on a counter surface of the appliance. The mixing motor can be used to mix the dry ingredients and liquid together by use of a magnetic connection with a magnetic stirrer in the container. In such a case, the mixing motor would be called the magnetic stirrer.

The mixing motor can also mix the dry and liquid ingredients together by use of a bottle assembly. The bottle assembly would typically include a bottle body and a removable bottle base with a stir bar in the bottle base for connection to the mixing motor. The bottle assembly also includes a nipple for use by a baby in a baby formula application. The connection between the stir bar and the mixing motor can be a mechanical connection. In this case, an extension of the mixing motor can protrude into the bottle base and power the rotation of the stir bar within the container. The connection between the mixing motor and the stir bar can also be magnetic, with a magnetic stirrer associated with the mixing motor, and a stir bar which turns by magnetic attraction to the magnetic stirrer, with the stir bar located inside the baby bottle or container.

The device can also include a bottle cleaner, which would be utilized to clean the container used for mixing the dry ingredients and liquid ingredients.

The purpose of the foregoing abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of the mixing appliance of the invention.

FIG. 2 is an exploded side of the bottle of the invention.

FIG. 3 is a perspective view of the water holding portion of the appliance.

FIG. 4 is a perspective view of the appliance showing the water bottle fitting on the mixer motor of the invention.

FIG. 5 is a view of one measuring technology of the invention.

FIG. 6 is a perspective view of a second embodiment of the invention with a bottle-washing unit.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

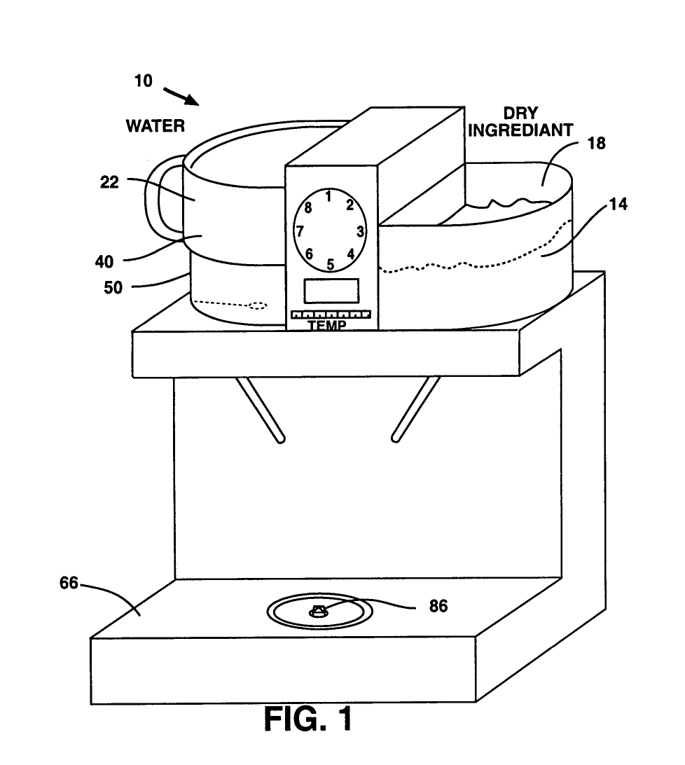

FIGS. 1-7 show several preferred embodiments of the mixing appliance of the invention, which is designated as 10. Shown in FIG. 1 is one preferred embodiment. This particular embodiment is configured for mixing powdered baby formula with water, but other configurations of this design can be utilized to mix other free flowing dry powders with other liquids. The embodiment shown in FIG. 1 includes a storage compartment 18 for storage of a dry ingredient 14, in this case powdered baby formula. The mixing appliance 10 also includes a liquid source 22. The liquid source 22 can be a plumbing connection to a building water supply or, as shown in FIG. 1, it can be a chamber 50, which is removable from the unit and which may be filled with a liquid 40. In this embodiment the liquid 40 would be water. The liquid 40 in the chamber 50 is kept at a selected temperature by a temperature control system 24. The embodiment shown in FIG. 1 also includes an appliance counter surface 66. Centered in the appliance counter surface 66 is a stir 62. A temperature selector 68 is also present, as well as a temperature gauge 92, an activation button 94, and a quantity selector 88.

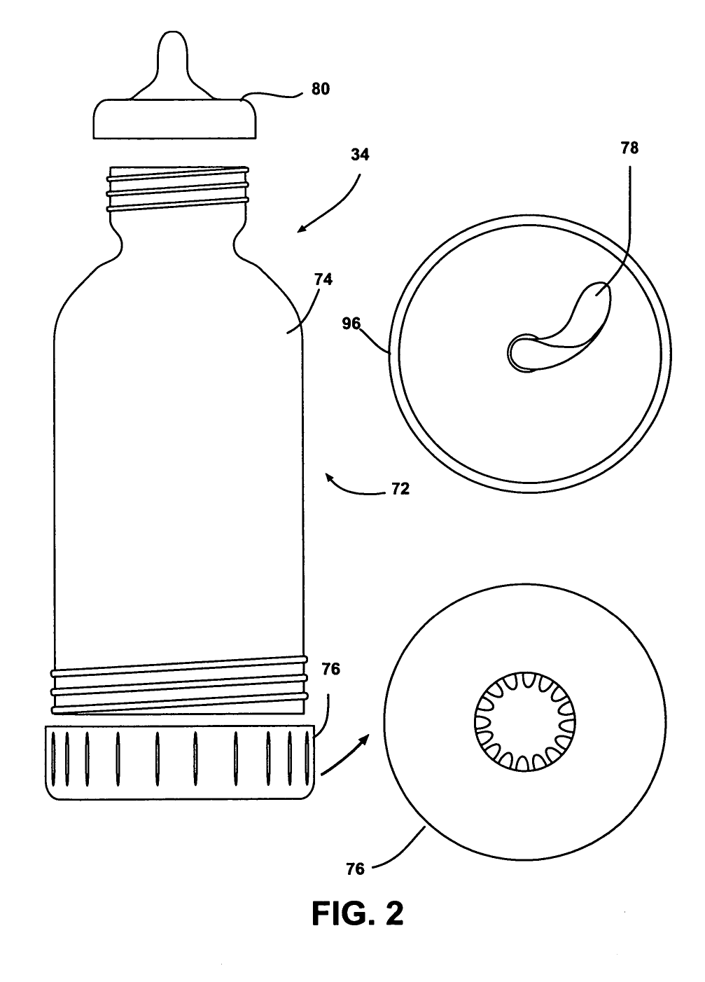

FIG. 2 shows an exploded side view of one version of a container 34. The version shown in FIG. 2 has a similar configuration to a conventional baby bottle, but it also includes a bottle base 76. It has a bottle body 74, and a screw on nipple 80. Built into the bottle base 74 is a base plate 96, which includes a stir bar 78. This unit assembles like a conventional mixer, with the base plate 96, and its attached stir bar, fitting into the bottle base 76. This is screwed onto the bottom of the generally cylindrical bottle body 74. Once the solution of formula and water have been mixed and added to the container 34, it can be removed from the appliance 10 for use, and a nipple 80 attached to it. Together, these form the bottle assembly 72.

The embodiment shown in FIG. 1 also includes a quantity selector, for the purpose of allowing the user to designate the quantities of formula to be made. For instance, if the user turns the setting to 4 on the unit-setting dial, quantities of liquid and dry ingredients appropriate for 4 ounces of formula would be prepared. Although the device is shown with the capability for making 8 ounces, obviously other capacities can be designed into the device for 10, 20, or 30 ounces. Also shown is an indicator light 82, which signals when the liquid in the chamber 50 has reached the selected temperature.

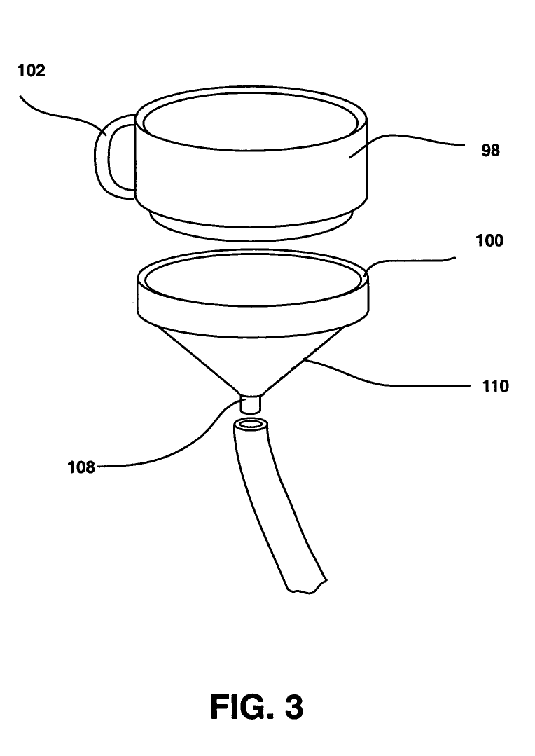

The chamber 50 in which liquid 40 is contained, can take a number of configurations. FIG. 3 shows one possible configuration. In this configuration the chamber 50 includes an upper unit 98 and a lower unit 100. The upper unit 98 includes a handle 102, and is preferably made of insulated plastic. It may contain an inner container 104, which is stainless steal. It also includes a first valve 106. The liquid 40 in the upper container 98 would preferably be heated to the selected temperature. A temperature sensor 108 would protect the temperature in the upper container 98. When activated by the unit setting dial, a measured amount of water from the upper chamber 98. In this embodiment, the lower unit 100 has a tapered structure which tapers to a second valve 108. A level sensor 110 is present in the lower section 100, and would shut off the flow of liquid at the first valve 106 when a selected amount of liquid is present in the lower unit 100. When activated, the second valve 108 would release that measured amount of liquid into the container 34.

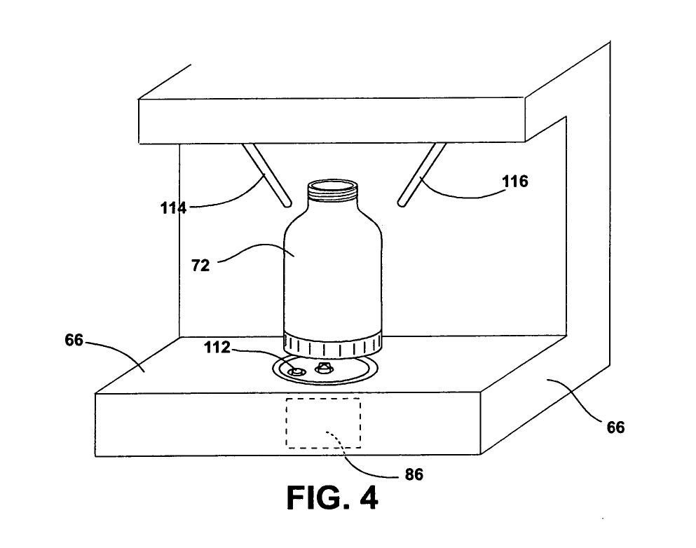

FIG. 4 shows a view of the container 34 on the base plate 66 of the mixing appliance 10. FIG. 4 shows the bottle assembly 72, the mixing motor 86 below the base plate 66, and a momentary switch 112, which activates the mixing motor 86 when contacted with the base of the bottle assembly 72. FIG. 4 shows a water dispenser nozzle 114 and a powder-dispensing nozzle 116, both of which direct their ingredients into the bottle assembly 72.

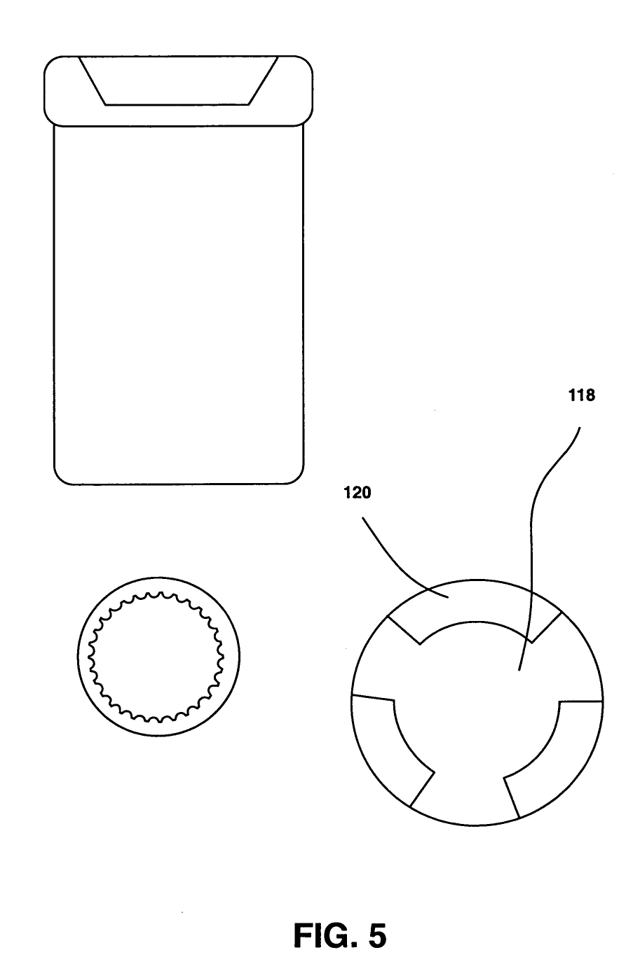

Dry ingredients can be measured and dispensed in a number of different manners and FIG. 5 shows one possible distinctive structure. This dispensing structure includes a measuring disc 118, in which are defined cavities 120. The volume of the cavities, and their position on the rotating disc 188, determines the volume of dry ingredient that is mixed and passed along to the bottle assembly 72. Shown is a measuring disc 118 with three cavities 120, which are located 120 degrees from each other. The measuring disc 118 would be given by a step motor, not shown, which would cause the disc to rotate 120 degrees. This could be driven by gears, which are configured to accommodate the 120-degree rotation of the disc.

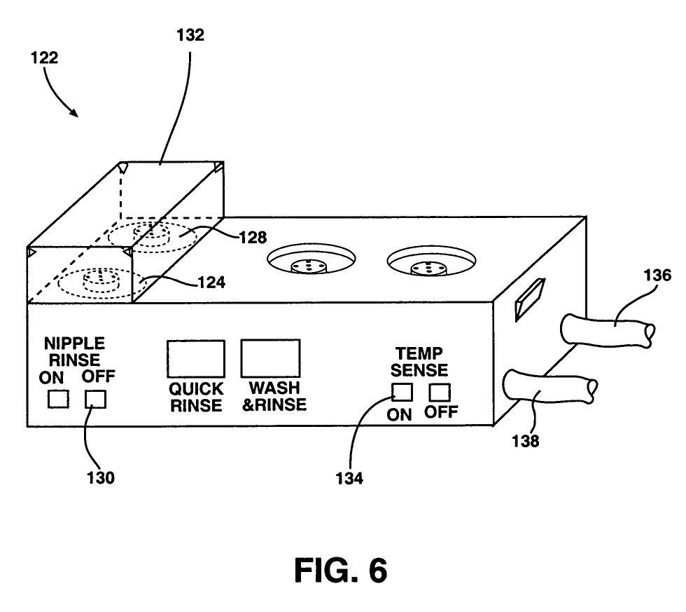

FIG. 6 shows another feature that may be utilized on an embodiment of the mixing invention. This feature is a bottle-washing unit 122. Bottle washing unit 122 includes spray nozzles 124. This configuration shows bottle washing positions 126 and nipple washing positions 128. Nipple washing positions 128 are activated by a switch 130, and this area is covered by a lid 132. The lid 132 prevents spray from the spray nozzles 124 from escaping from the nipple washing area. The bottle washing positions 126 enable a bottle assembly to be screwed on upside down and sprayed from below in order to clean the interior of the bottle body. The bottle washing positions 126 include water drains for draining away the water used for cleaning the interior of the bottles. A temperature-sensing unit 134 is also present, which may be switched on and off. Also shown, are a water in fixture 136 and a water out fixture 138. Both the water in 136 and water out 138 connections are connected to a plumbing system. One preferred embodiment of the bottle-washing unit would include the bottle-washing unit 122 to be attached to a part of the mixing appliance 10. It would also be possible to have a separate unit, which is utilized in conjunction with the mixing unit 10, perform a mixing and cleaning system.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A mixing appliance for making liquid foods from dry ingredients:
one or more storage compartments for storing one or more dry ingredient, for use in preparing a selected liquid food;
a liquid source, for supplying a liquid for mixing with said one or more dry ingredients;
a temperature control system, for developing a selected temperature in said liquid before quantity of dry ingredient of said liquid is added to said one or more dry ingredients for mixing;
a first measuring unit, for measuring a quantity of dry ingredient of said one or more dry ingredient for mixing with said liquid, and for sending a measured quantity for mixing;
a second measuring unit, for measuring a quantity of liquid for mixing;
a container, for receiving a measured quantity of dry ingredient and a measured quantity of liquid;
a mixing system, for mixing said measured quantity of dry ingredients and said measured quantity of liquids, in said container.

2. The mixing appliance of claim 1, which comprises a single storage compartment, for storing a single dry ingredient for mixing with said liquid.

3. The mixing appliance of claim 1, in which said mixing appliance is configured to mix multiple dry ingredients.

4. The mixing appliance of claim 1 in which said liquid source is a chamber available for manual filling by a user.

5. The mixing appliance of claim 1 in which said liquid source is a connection to a building plumbing system.

6. The mixing appliance of claim 4 in said temperature control system is configured to heat said liquid in said chamber to said selected temperature.

7. The mixing appliance of claim 5 in said temperature control system is configured to heat said liquid from said connection to a building plumbing system to a selected temperature as said liquid enters said container

8. The mixing appliance of claim 1 in which said first measuring unit is a screw type measurer.

9. The mixing appliance of claim 1 in which said first measuring unit is a weight based measurer.

10. The mixing appliance of claim 1 in which said first measuring unit is a rotating disk with a volume based measuring depression.

11. The mixing appliance of claim 1 in which said second measuring unit measures said liquid by volume before sending said liquid to said container for mixing.

12. The mixing appliance of claim 1 in which said mixing system comprises a magnetic stirrer under a base plate.

13. The mixing appliance of claim 4, which further includes a temperature selector, with which a user may select a desired temperature for said liquid.

14. The mixing appliance of claim 1, in which said mixing system includes a mixing motor in an appliance counter surface, for mixing said dry ingredient with said liquid.

15. The mixing appliance of claim 1, which further includes a bottle assembly comprising a bottle body, a removable bottle base with a stir bar for connection with said mixing motor, and a nipple.

16. The mixing appliance of claim 15, in which a connection is formed between said stir bar and said mixing motor which is a mechanical connection.

17. The mixing appliance of claim 14, which further includes a bottle assembly comprising a bottle body, a removable bottle base with a magnetic stir bar for connection with said mixing motor, and a nipple.

18. The mixing appliance of claim 17, in which a connection is formed between said stir bar and said mixing motor which is a magnetic connection.

19. The mixing appliance of claim 1, which further includes a bottle cleaner assembly.

20. The mixing appliance of claim 1, which further includes a bottle cleaner station.
